(19) United States
(12) Patent Application Publication
(10) Pub. No.: US 2026/0125836 A1
(43) Pub. Date: May 7, 2026

(54) A sleeve for a drum

(71) Applicant: Suominen Oyj, Espoo (FI)

(72) Inventors: Charlie Blackwell, Espoo (FI); Gian Luca Polosa, Espoo (FI); Justin Boncher, Espoo (FI); Tero Haaparanta, Espoo (FI); Pasi Pirhonen, Espoo (FI); Joni Naski, Espoo (FI)

(21) Appl. No.: 19/118,802

(22) PCT Filed: Oct. 4, 2023
(86) PCT No.: PCT/FI2023/050566

§ 371 Date: Apr. 7, 2025

Related U.S. Application Data
(60) Provisional application No. 63/413,263, filed on Oct. 5, 2022.

(51) Int. Cl. D04H 18/04; B33Y 80/00

(52) U.S. Cl. CPC D04H 18/04; B33Y 80/00

(57) ABSTRACT

According to an aspect of the present invention, there is provided a sleeve for a drum for use in forming, pressing or moulding a fibrous web, wherein the sleeve comprises at least two parts and each part has a form of an open-ended cylinder with two edges, configured to be arranged concentrically on the drum. At least one edge of each part has a peripheral locking form, and adjacent edges of adjacent parts have corresponding cooperating peripheral locking forms adapted to lock the parts to each other.

### FIELD

The present invention relates to a sleeve for a drum for use in forming, pressing or moulding a fibrous web, as well as to a use of such sleeve. The present invention further relates to a roll for use in forming, pressing or moulding a fibrous web.

### BACKGROUND AND OBJECTS

The surface structure of various webs, e.g. tissue paper and nonwoven fabrics, may be modified during production to obtain a pattern of raised or compressed portions. The obtained pattern may also include apertures in the web. Patterning can be done both for aesthetic reasons and in order to provide desired performance enhancements in the product. The process of imposing patterns on a web is often referred to as embossing.

The pattern may be imposed by a number of methods, involving wires or rolls having protrusions, valleys and orifices corresponding to the pattern which is to be imprinted on the web surface. Heat and pressure may be used. In the production of nonwoven fabric, hydroentangling is a widely employed method in which arrays of nozzles are arranged perpendicularly to the web in order to direct distinct sprays of water against the moving web surface. The force of the water sprays mix and entangle the fibres of which the web is constituted, and thus bonding of the web is achieved. Simultaneously, if the roll or wire surface carrying the moving web has a pattern, a corresponding pattern is formed in the web.

In order to vary the patterns, a number of rolls or wires having the corresponding structure must be kept available.

In the case of rollers, they must be discarded or refurbished when their surface structure wears out. A solution to this problem has been to replace monolithic embossing rollers with rotatable support structures to which replaceable sleeves are torsionally coupled. This approach is commonly used in the field of printing, but the field of embossing presents different technical challenges.

Additive manufacturing is a term used for describing a set of technologies for creating three-dimensional objects by successive addition of material layers. A type of additive manufacturing is 3D printing, of which a number of varieties exist. Stereolitography is a 3D printing technology for the production of objects by a layer-by-layer process using photopolymerisation. A light-emitting device under computer control selectively illuminates portions within a container containing a photopolymerising resin, causing small amounts of resin to cure and adhere to sections of the object being manufactured. In an inverted stereolitography process, the manufactured object is progressively lifted out of the resin bath, with successive layers of hardened resin being added to the underside of the object. In the non-inverted version, the object is formed within the resin bath by adding material to its top, which requires a volume of uncured resin corresponding to the size of the product.

Other 3D printing methods include Digital Light Processing (DLP), Fused Deposition Modelling (FDM), Selective Laser Sintering (SLS), Selective Laser Melting (SLM), Electron Beam Melting (EBM) and Laminated Object Manufacturing (LOM).

3D printing a sleeve for a drum would require large spaces, as for example the width of a drum for a nonwoven machine is typically 2-6 m. Thus, it would be desirable to be able to make the sleeve from smaller parts arranged next to one another. Smaller parts would also make it easier to change the sleeves, as smaller space next to the machine would be required, as well as less personnel and lighter equipment. Most advantageously, such parts could even be changed by a single person, without any need for lifts or other equipment.

However, the line speeds of nonwoven machines and hence the rotation speeds of drums are such that if a sleeve were made of parts, the parts would rotate at different speeds, leading to defects in the patterning as well as probable problems of distortion of the parts. Such distortion could then easily lead to breakage of the parts, leading to production losses and additional costs.

An aim of the present invention is thus to provide a sleeve for a drum for use in forming, pressing or moulding a fibrous web, that can be manufactured by 3D printing in a cost effective manner. Such sleeves would be easier to transport, assemble and dismount, as well as replace, in particularly partly replace. A further aim is to provide a sleeve where distortion is minimised and a uniform pattern for the fibrous web is obtained.

It is a still further aim to provide a sleeve wherein changes of environmental conditions do not affect the function of the sleeve. The sleeve should also take into account the fact that especially during acceleration and deceleration, the forces affecting the segments of the sleeve vary. Ends of the sleeve are subject to more torque than the middle part, since the ends are attached to the drum, while the middle part is not.

### SUMMARY OF THE INVENTION

The invention is defined by the features of the independent claims. Some specific embodiments are defined in the dependent claims.

According to a first aspect, there is provided a sleeve for a drum for use in forming, pressing or moulding a fibrous web, wherein
the sleeve comprises at least two parts,
each part having a form of an open-ended cylinder with two edges, configured to be arranged concentrically on the drum,
at least one edge of each part has a peripheral locking form, and
   wherein adjacent edges of adjacent parts have corresponding cooperating peripheral locking forms adapted to lock the parts to each other.

According to a second aspect, there is provided a use of a sleeve as described above, with an embossing roller.

According to a third aspect, there is provided a roll for use in forming, pressing or moulding a fibrous web, comprising
a drum comprising a backplate,
a sleeve as described above, arranged concentrically on the drum, and
a compression collar for compressing the sleeve on the drum between the backplate and the collar, the collar comprising:
   an inner part configured to be attached to an end of the drum,
   an outer part, and
   a slip part between the inner part and the outer part, which slip part is configured to be engaged with the sleeve,
wherein
   the inner part, the slip part and the outer part are assembled together in succession along an assembly axis, and
   the slip part is configured to translate between the inner part and the outer part along the assembly axis.

### BRIEF DESCRIPTION OF THE DRAWINGS

FIGS. 1A-1E illustrate various locking forms according to some embodiments.

FIG. 2 illustrates a locking form according to an embodiment.

FIG. 3 illustrates a variant of the locking form of FIG. 2.

FIGS. 4 and 5 illustrate further variants of the locking form according to embodiments.

FIG. 6 illustrates yet another variant of the locking form, according to an embodiment.

FIG. 7 illustrates a sleeve according to one embodiment, as a side view.

FIG. 8 illustrates a collar according to an embodiment.

FIG. 9A illustrates an inner surface of an inner part according to an embodiment.

FIG. 9B illustrates an outer surface of an inner part according to an embodiment.

FIG. 10 illustrates a slip part according to an embodiment.

FIG. 11A illustrates an inner surface of an outer part according to an embodiment.

FIG. 11B illustrates an outer surface of an outer according to an embodiment.

FIG. 12 illustrates a biasing mechanism according to an embodiment.

FIG. 13 illustrates a pivot according to an embodiment.

FIG. 14 illustrates a groove on an outer perimeter of the collar and a wedge configured in the groove according to an embodiment.

FIG. 15 illustrates a wedge configured to be placed in the groove.

### DETAILED DESCRIPTION

The present description relates to a sleeve for a drum for use in forming, pressing or moulding a fibrous web, wherein
the sleeve comprises at least two parts,
each part having a form of an open-ended cylinder with two edges, configured to be arranged concentrically on the drum,
at least one edge of each part has a peripheral locking form, and
   wherein adjacent edges of adjacent parts have corresponding cooperating peripheral locking forms adapted to lock the parts to each other.

In the present description, the terms nonwoven fabric and nonwoven may be used interchangeably. The terms peripheral locking form and locking forms may also be used interchangeably.

The invention thus relates to an equipment for use in the production of nonwoven fabrics and paper products. The present description provides a sleeve made of at least two parts, which have a peripheral locking form for locking the parts to each other. The locking forms of the parts can be identical or different, provided that the locking forms of adjacent edges of adjacent parts fit one another for locking the parts to each other. The present sleeve made of at least two parts at least partially solves the problems mentioned above.

The sleeve is suitable to be used with a drum for use in forming, pressing or moulding a fibrous web, but naturally the same principle can be used for any other type of sleeve that is mounted on a cylindrical support and rotates at a high speed. For example, the present sleeve could be used as an embossing sleeve.

Each part of the sleeve has a form of an open-ended cylinder with two edges, and they are configured to be arranged concentrically on the drum. This means that the rotational axis of the sleeve and sleeve parts is identical to the rotational axis of the drum. The sleeve and sleeve parts typically fit tightly on the drum, such that the sleeve rotates together with the drum and does not have any phase difference with it. Such the sleeve not fit tightly, the high rotational speeds could damage and distort it. The sleeve can be made of a material that swells slightly when subject to humidity, meaning that when it dries, it shrinks on the drum. The sleeve is attached to the drum at its ends. Advantageously the sleeve is fitted on the drum in such a manner that firstly the sleeve parts stay tightly together and do not get loose with respect to one another, and secondly the sleeve remains essentially static with respect to the sleeve during use of the drum. Even more advantageously, the sleeve is fitted on the drum in a manner that allows for some swelling and shrinking of the parts, i.e. that the attachment means allow for some movement of the parts due to dimensional changes.

Each part of the sleeve has at least one edge having a peripheral locking form. Not all parts need to have such locking forms, typically the parts that form ends of the sleeves have outer edges without locking forms. The locking forms are thus at one end or both ends of the parts, and a peripheral, i.e. around the circumference of the part. The locking forms are such that when the sleeve is mounted, adjacent edges of adjacent parts have corresponding cooperating peripheral locking forms adapted to lock the parts to each other.

The locking forms are such that they take into account the forces applied to different parts of the sleeve, due to acceleration and deceleration. Furthermore, the locking forms are such that the parts cannot slip in relation to each other, and that there are no distortions on the sleeve parts. The edges and locking forms of the parts are also such that the pressure remains even on the whole circumference of the part, to prevent cracks, distortions or sliding of one part under another part.

Advantages of the present sleeve include in the manufacturing process increased overall equipment effectiveness, as the smaller parts do not require a 3D printing machine capable of printing an entire commercial sleeve. The same reason allows reduction of sleeve production time, as parallel machines can be used for manufacturing several parts at a same time. Furthermore, in case of a problem in the 3D printing, resulting for example in a misprint, only the defective part needs to be re-printed. Also, during use of the sleeve, if one part needs replacement, it is easy to simply replace this part, instead of the whole sleeve. This creates also a significant economical benefit. It is also believed that the present sleeve can be manufactured with increased precision. The present sleeve can also be manufactured in a more versatile manner, as the dimensions, especially the width, of the sleeve parts can be easily adjusted. It would even be possible to have a few standardised sizes of sleeve parts, of which it would be possible to construct any size of sleeve. The productions costs can also be lower with the present sleeve compared to traditional sleeves.

For the installation of the sleeve, the present sleeve has the advantage that the smaller parts are easier to install than a full sleeve, less space is required for the replacement, as well as less personnel. It is also believed that installing the present sleeve on a drum is safer than installing a full sleeve. For example, one part of the sleeve could have a width of 50 cm, and a weight of for example 3 kg. Such parts are easily handled by a single person, whereas a sleeve having a width of 4 m and a weight of 24 kg requires at least two persons because of the weight, and probably even three persons and/or lifting equipment because of the width.

From the maintenance point of view, the present sleeve has the advantage that in case of wear or breakage of a part of the sleeve, only the part concerned can be replaced, instead of the full sleeve as in the traditional cases. Furthermore, since the parts are 3D printed, it is possible to easily make an exact copy of the original part.

According to an embodiment, the parts forming ends of the sleeve have outer edges where a part of points of the edge fall on a same plane, which plane is perpendicular to a rotational axis of the sleeve. According to another embodiment, the parts forming ends of the sleeve have outer edges where all points of the edge fall on a same plane, which plane is perpendicular to a rotational axis of the sleeve. The outer edges of the finished sleeve are thus preferably void of locking parts. Instead, the outer edges are as if the sleeve part had been cut perpendicular to a rotational axis of the sleeve, which rotational axis of the sleeve is also the rotational axis of the sleeve part. Such straight ends of the sleeves allow the sleeve parts to be gently pressed together from both ends of the sleeve, which is believed to best ensure that the parts stay properly locked to one another, even when the drum is rotating at a high speed, and even if the sleeve parts swell or shrink depending on for example the humidity or temperature conditions.

The sleeve comprises at least two parts, and may comprise three, four, five, six, seven, eight, nine, ten or more parts.

In case the sleeve comprises three parts, the parts may be as follows and have the following edge structures:
a first part having a first outer edge and a second edge with a peripheral locking form,
a second part having a first outer edge and a second edge with a peripheral locking form, and
a third part arranged between the first and the second parts, having peripheral locking forms at its both edges, for locking the parts together.

In this scenario, the first and second parts thus form the ends of the sleeve, while the third part is arranged in between these end parts. The peripheral locking forms of the third part may be identical or corresponding, or they may be different, as long as they correspond to the peripheral locking forms of the corresponding edges of the first and second parts.

In case the sleeve comprises more than three parts, the additional parts are similar to the third part described above, and the third parts are arranged adjacent to one another between the first and second parts.

According to another embodiment, the peripheral locking forms are selected from a group consisting of sinusoidal forms, zigzag-forms, wave forms. It is believed that different types of wave forms would be close to optimal, but in many cases the actual pattern would define the locking form. This is discussed further below. A particular advantage of wave forms is that they typically create close to optimal combination of locking the pieces together without risking the durability, thus limiting the amount of weak points in the sleeve assembly.

As mentioned above, the locking forms of adjacent parts need to correspond to one another, but do not all need to be similar in case there are more than two parts. In case of the forms listed above, the forms may be such that corresponding forms are in fact identical (such as a regular zigzag-form), or they may be mirror images (for example wave forms with varying wave lengths). As the parts are cylindrical and due to their nature and use as a sleeve, rotationally symmetrical, the parts can be arranged on the drum at any rotational position.

In this embodiment, the locking forms extend in the direction of rotation of the sleeve, i.e. the locking form is visible when the parts are arranged adjacent to one another.

According to another embodiment, one peripheral locking form is a female form and the adjacent peripheral locking form is a corresponding male form. The forms may be any suitable forms, such as a rounded or rectangular slot and the corresponding projection. This embodiment is similar to those listed above in that the male forms extend also in the direction of the axis of rotation of the sleeve. In this embodiment, there are preferably 2-8 locking forms for each part, most preferably equally distributed along the circumference of the parts.

Based on experiments, it is believed that the above type of locking forms, i.e. forms that extend in the direction of the axis of rotation of the sleeve are ideal for parts made of materials that swell or shrink in varying environmental conditions, such as humidity and/or temperature.

According to yet another embodiment, one peripheral locking form comprises at least two protrusions and the adjacent peripheral locking form comprises corresponding recesses. In this embodiment, the peripheral locking forms differ from those of above in that the edges of the parts have a lip area with a smaller wall thickness than the majority of the sleeve part, this lip area being flush with either the outer surface of the sleeve part or the inner surface of the sleeve part. When two parts are arranged adjacent to one another, the two lip areas fit together to form an area with a combined wall thickness essentially equal to the wall thickness of the part. One of the lip areas then has protrusions, while the other has recesses. The recesses may also be through holes. The protrusions may be directed towards the outer surface of the part, i.e. the surface that is towards the outside of the drum when the sleeve is mounted on the drum, or towards the inner surface of the part.

In this case, the number of protrusion and corresponding recesses is preferably from 6 to 24, depending also on the diameter of the sleeve. Most preferably, the protrusions and recesses are arranged regularly around the circumference of the sleeve parts.

According to an embodiment, part of the locking forms are identical or similar, while part are different. According to another embodiment, all locking forms are similar or identical. Also, all the peripheral locking forms are preferably zigzag-forms, and most preferably zigzag-forms of same size, i.e. the parts can be arranged at any position on the drum. Indeed, based on experiments, it is believed that a uniform zigzag-form is best for guaranteeing that the sleeve parts stay aligned with each other, even at high rotation speeds. It is furthermore believed, based on experiments, that parts with such locking forms stay also straight compared to each other.

According to a further embodiment, the sleeve parts are patterned. The circular locking form may be part of the pattern. Indeed, such design ensures that the location of the locking form practically disappears into the pattern of the finished fibre product, i.e. the finished product has a uniform structure over its whole width. Indeed, in most cases a wave form locking results in an end result where the locking form is well enough hidden. However, in the case of some patterns, it is also possible to take advantage of the features of the pattern to hide it in the end result. Thus, the locking form can be selected to take advantage of the pattern features to hide the unlikely visible seam and do not necessarily need to be designed as a part of the pattern.

According to an embodiment, the parts of the sleeve are manufactured by additive manufacturing. The additive manufacturing is preferably stereolithography.

Indeed, most preferably, the sleeve parts are produced using 3D printing. Preferably, the technique used is stereolithography. These technologies permit the preparation of pattern-forming and dewatering details in the sleeve in a single operation. The dewatering properties may thus be optimised for the selected pattern, resulting in uniform dewatering tailored for the pattern.

The use of 3D printing technology brings the full benefits of CAD to sleeve design. The technology allows for great variation in the structure, i.e. variation of the pattern along all directions of the sleeve surface. Since the design is fully transferable and scalable, the preparation of both prototype and production scale sleeves may be significantly faster than when using prior art methods for making metal sleeves. A further advantage is the possibility of repair. Since all structural details are stored digitally, an exact replacement part for any damaged part may be prepared on demand.

Some suitable materials for the sleeve parts are various plastics, ceramics and metals, including alloys and composite materials. Exemplary materials for use in the present invention are is provided in U.S. patent application Ser. No. 17/262,799, which is incorporated herein by reference.

Preferably, the sleeve is designed for hydroentangling a web of fibres, whereby the fibres may be of any type suitable for producing a web by hydroentangling.

The present sleeve and in consequence sleeve parts has a suitable wall thickness, for example a wall thickness of at least 5 mm. The wall thickness can be for example from 1 to 6 mm, such as 1 mm, 3 mm, 5 mm or 6 mm.

According to a second aspect, there is provided a use of a sleeve as described above, with an embossing roller.

According to a third aspect, there is provided a roll for use in forming, pressing or moulding a fibrous web, comprising
a drum comprising a backplate,
a sleeve as described above, arranged concentrically on the drum,
a compression collar for compressing the sleeve on the drum between the backplate and the collar, the collar comprising:
   an inner part configured to be attached to an end of the drum,
   an outer part, and
   a slip part between the inner part and the outer part, which slip part is configured to be engaged with the sleeve,
wherein
the inner part, the slip part and the outer part are assembled together in succession along an assembly axis, and
the slip part is configured to translate between the inner part and the outer part along the assembly axis.

The roll comprises thus a drum comprising a backplate, as is known in the art, a sleeve described herein, and a compression collar. The sleeve is arranged between the backplate and the compression collar, which is pressing the sleeve segments against the backplate with even pressure.

In the present context, the term “an inner surface of an inner part” refers to a surface of the inner part, which is facing an outer part, when parts of a collar are assembled together. The term “an outer surface of an inner part” refers to a surface of the inner part, which is on opposite side of the inner part than the inner surface. The term “an inner surface of an outer part” refers to a surface of an outer part, which is facing the inner part, when parts of the collar are assembled together and the term “an outer surface of an outer part” refers to a surface of the outer part, which is on opposite side of the outer part than the inner surface. According to an embodiment, the collar for compressing the sleeve on the drum comprises an inner part configured to be attached to an end of the drum, an outer part, and a slip part between the inner part and the outer part. The slip part is configured to be engaged with the sleeve. The inner part, the slip part and the outer part are assembled together in a succession along an assembly axis. The slip part is configured to translate between the inner part and the outer part along the assembly axis.

The collar provides an even pressure along the entire circumference of the sleeve by the slip part, thus keeping the sleeve on its place and straight. By “even pressure” is meant that the pressure is in the range of +/−10%, preferably +/−5%, more preferably +/−2%, along the entire circumference of the sleeve. In the case of the sleeve having at least two parts, the line speeds of nonwoven machines and hence the rotation speeds of drums are such that if a sleeve were made of parts, the parts would rotate at different speeds, leading to mistakes in the patterning as well as probable problems of distortion of the parts. Such deformation or distortion could then easily lead to breakage of the parts, leading to production losses and additional costs. The collar ensures that the parts stay aligned with each other. Further, the collar provides an even pressure to the parts in the ends and in the middle of the sleeve. The collar is able to compensate the deformation of the sleeve, by the translation of the slip part between the inner part and the outer part. Thus, the slip part moves between the inner part and the outer part as a result of an increase or decrease in the force caused by the deformation of the sleeve on the slip part in a longitudinal direction of the drum. Thus, the collar can prevent the sleeve from breakage. So, production losses and additional costs can be avoided.

The sleeve can be a one-piece sleeve or it can comprise at least two parts. The at least two parts can have peripheral locking forms adapted to lock the parts to each other.

According to an embodiment, the slip part is configured to translate 20-40 mm, preferably 25-35 mm, between the inner part and the outer part. Thus, the collar is able to compensate the deformation of the sleeve even in a case wherein an amount of deformation is high, for example, in a case of a substantially long sleeve and severe moisture and/or temperature changes.

According to an embodiment, the slip part comprises a flange extending perpendicularly to the assembly axis. The flange comprises a first surface and an opposite second surface. The first surface faces the sleeve and is configured to engage the sleeve on the drum. The flange provides reliable attachment of the sleeve on the drum. The flange secures that the sleeve cannot protrude over the collar, but stays firmly attached on the drum.

According to an embodiment, the slip part comprises several mounting attachments protruding towards a centre of the slip part perpendicularly to the assembly axis. The mounting attachments can be arranged at regular intervals at the slip part. The slip part can comprise for example, four, six, eight or ten mounting attachments. The mounting attachments enable assembling the slip part with the inner part and the outer part along the assembly axis.

The inner part and the outer part can comprise several mounting recesses for receiving the mounting attachments of the slip part. A number of the mounting recesses can be, and preferably is, equal to the number of the mounting attachments. The inner part and the outer part can comprise for example, four, six, eight or ten mounting recesses. A shape of the mounting recesses preferably corresponds the shape of the mounting attachments. The mounting recesses can be formed on an inner surface of the inner part and an inner surface of the outer part. The mounting recesses of the inner part form with the mounting recesses of the outer part a sledge where the mounting attachments can translate between the inner part and the outer part in the direction of the assembly axis.

According to an embodiment, the collar further comprises several biasing mechanisms arranged inside the sleeve compression collar, extending between the slip part and the outer part in a direction of the assembly axis. The biasing mechanisms are able to conform and assist in the translation of the slip part.

The several biasing mechanisms can be arranged at regular intervals in the sleeve compression collar. Preferably, the biasing mechanisms are arranged in pairs, so that one biasing mechanism is placed on the opposite side of the circumference of the collar than the other biasing mechanism of the pair. Thus, the biasing mechanism assists in providing an even pressure along the entire circumference of the sleeve.

The collar can comprise four to ten biasing mechanisms, such as four, six, eight or ten biasing mechanisms. Thus, the collar comprises enough of the biasing mechanisms to provide an even pressure along the entire circumference of the sleeve.

According to an embodiment, the several biasing mechanisms are configured to extend through the several mounting attachments. Thus, biasing mechanisms are connected to the slip part and are thus able to conform and assist in the translation of the slip part.

According to another embodiment, the several biasing mechanisms comprise coil springs or leaf springs. Thus, the coil springs or leaf spring extend between the inner part and the outer part inside the collar substantially in a direction of the assembly axis. The coil springs or leaf springs are configured to shorten or extend as a result of an increase or decrease in the force on the slip part in the direction of the assembly axis.

A spring force of the coil spring can be 200 to 400 Nm, preferably 250 to 350 Nm.

A length of the coil spring can be configured to shorten or extend 10 to 20 mm, preferably 12 to 17 mm, from an initial length of the coil spring. Thus, the collar is able to compensate deformation of the sleeve with an aid of the coil springs even in a case where an amount of the deformation is high, for example, in a case of a substantially long sleeve and severe moisture and/or temperature changes.

According to an embodiment, a pivot is configured to extend through the coil spring in a longitudinal direction of the coil spring. The pivots can extend from an outer surface of the outer part to inside of the inner part. Heads of the pivots can be arranged inside the outer part so that a surface of the head is substantially at the same level than the outer surface of the outer part. The pivot secures that the coil spring stays straight.

An outer surface of the outer part can comprise several pivot recesses for receiving the heads of pivots.

The end of the pivot can comprise a recess for receiving a fastening means, such as screws. The fastening means can extends from the inner part to inside of the recess for attaching the end of the pivot to the inner part. A head of the screw can be substantially at the same level than the outer surface of the inner part.

The inner part can comprise several fastening apertures for receiving a pivot and for attaching the inner part to an end of the pivot. In other words, the fastening apertures are for securing the pivot and binding parts of the collar, i.e. the inner part, the slip part and the outer part, together. A number of the fastening apertures can be, and preferably is, equal than a number of the pivots. The inner part can comprise for example four, six, eight or ten fastening apertures. The fastening apertures can be configured at regular intervals at the inner part.

According to an embodiment, the collar further comprises a plurality of pins (not illustrated) extending from the inner part to the outer part to centre the inner part and the outer part relative to each other. Thanks to the pins, it is easier to centre the inner part and the outer part relative to each other during an assembly stage of the collar.

The inner part and the outer part can comprise attachment apertures for attaching the collar to an end of the drum. The collar can be attached to the end of the drum by fastening means, such as bolts, via the attachment apertures. The fastening means extend from the outer part to the inner part via the attachment apertures. The inner part and the outer part can, and preferably does, comprise an equal amount of the attachment apertures. The inner part and the outer part can comprise for example, four, six, eight or ten attachment apertures. The attachment apertures can and preferably are arranged at regular intervals to the inner part and the outer part.

Alternatively, the outer part can comprise several protrusions and the inner part can comprise respective recesses for receiving the protrusions, or vice versa. According to an embodiment, the collar further comprises a groove on an outer perimeter of the collar and a wedge configured to be arranged in the groove, which wedge is attached to the slip part. The groove can extend in the direction of the assembly axis. The groove can extend from the inner part to the outer part. The wedge can be attached to the slip part by fastening means, such as screws, perpendicularly of the direction of the assembly axis. The wedge locks the inner part, slip part and outer part relative to each other so that the part cannot rotate relative to each other.

According to an embodiment, a drum for use in forming, pressing or moulding a fibrous web comprises the collar.

According to an embodiment, the collar of the drum comprises the slip part comprising a flange extending perpendicularly to the assembly axis, which flange has a first surface facing the drum and an opposite second surface, which first surface is configured to engage a sleeve on the drum. The flange provides reliable attachment of the sleeve on the drum. The flange secures that the sleeve cannot protrude over the collar, but stays firmly attached on the drum.

According to an embodiment, the collar of the drum comprises several biasing mechanisms arranged inside the sleeve compression collar extending between the slip part and the outer part in a direction of the assembly axis, which several biasing mechanisms are configured to adapt to a change in force on the slip collar caused by the deformation of the sleeve. Thus, the biasing mechanisms are able to conform and assist in the translation of the slip part. Further, the biasing mechanism assist in providing an even pressure along the entire circumference of the sleeve.

According to an embodiment, a nonwoven web machine comprises a collar as described above. Thus, the collar can be part of the nonwoven web machine used in forming, pressing or moulding a fibrous web.

According to another embodiment, a method for installing a sleeve on a drum comprises providing the sleeve on the drum, and attaching the collar to an end of the drum for creating an even pressure along the entire circumference of the sleeve. The method provides a reliable and cost-effective way to install the sleeve on a drum.

### DETAILED DESCRIPTION OF THE DRAWINGS

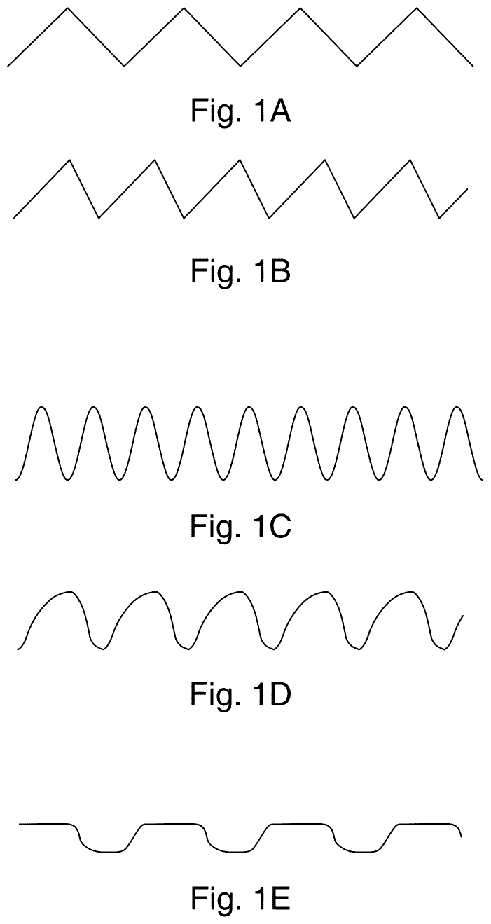

FIGS. 1A-1E illustrate various locking forms according to some embodiments. In these embodiments, the peripheral locking forms are in the form of a zigzag (FIGS. 1A and 1B), a sinusoid (FIG. 1C) or a wave (FIGS. 1D and 1E). The corresponding locking forms are mirror images, which in the case of the forms of FIGS. 1A and 1C means that the corresponding locking form is identical to that illustrated.

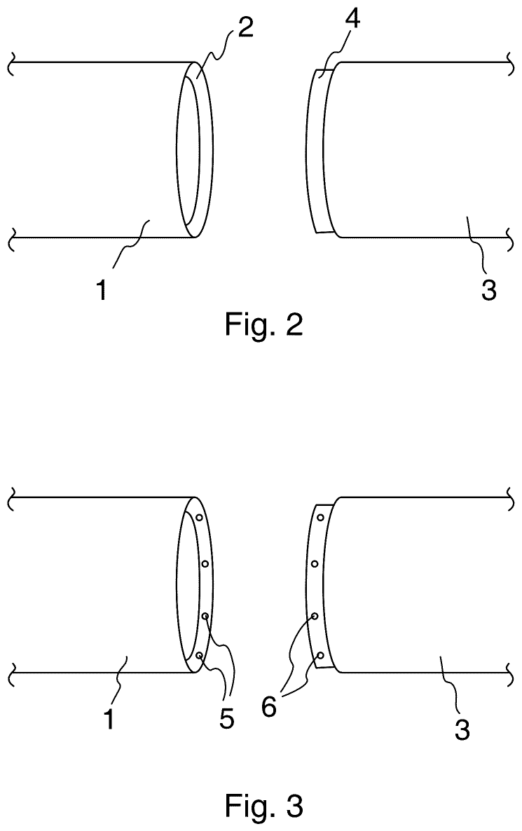

FIG. 2 illustrates a locking form according to an embodiment. In this embodiment, the first part 1 comprises a first lip part 2 towards the inner volume of the part, i.e. its outer surface is even while its inner surface is thinner the rest of the part. The second part 3 has a corresponding lip part 4 which is flush with the inner surface of the sleeve part, and arranged to fit within the first lip part 2.

FIG. 3 illustrates a variant of the locking form of FIG. 2. In this embodiment, the first part 1 has a lip part as in FIG. 2, but the lip part comprises recesses 5. The second part 3 has corresponding protrusions 6 at its lip part, at appropriate positions to lock the two parts together.

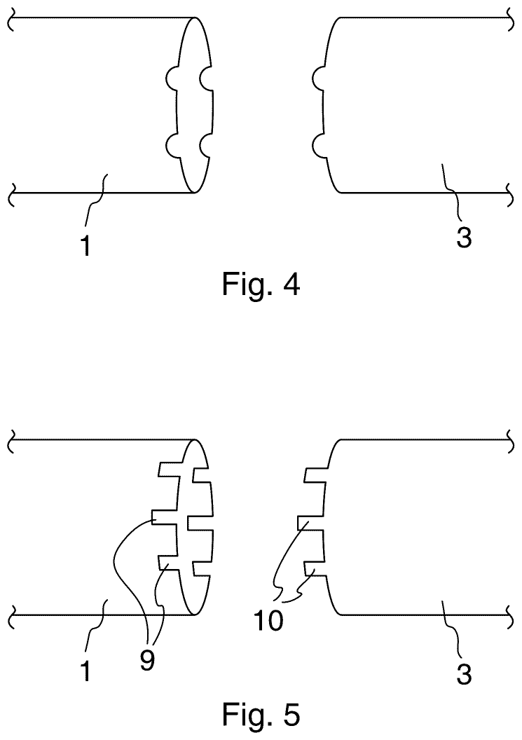

FIGS. 4 and 5 illustrate further variants of the locking form according to embodiments. The embodiments have male and female locking forms. In the embodiment of FIG. 4, the first part 1 has female forms 7 while the second part 3 has corresponding male forms 8. In the embodiment of FIG. 5, the female forms 9 and male forms 10 are rectangular, but the forms may naturally have any desirable shape and size.

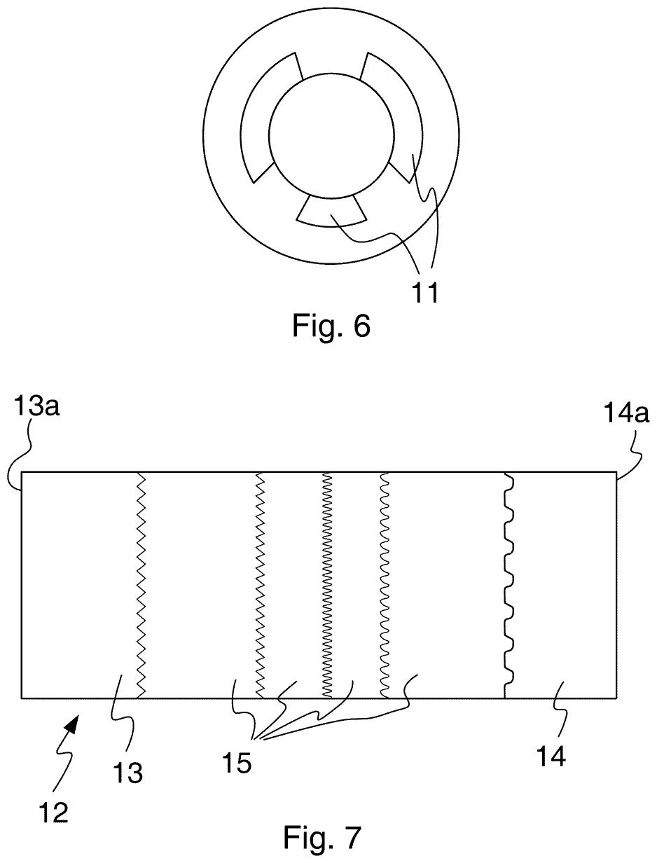

FIG. 6 illustrates yet another variant of the locking form, according to an embodiment. In this embodiment, one of the parts has recesses 11, while the other part has corresponding protrusions. The recesses and protrusions are preferably wedge-shaped. This is thus a non-symmetric locking solution.

FIG. 7 illustrates a sleeve according to one embodiment, as a side view. The sleeve 12 consists of six parts, end parts 13 and 14, as well as four middle parts 15. The locking forms vary from one intersection to another, while some being identical. The outer edges 13a and 14a of the end parts 13 and 14, respectively, do not have any locking forms.

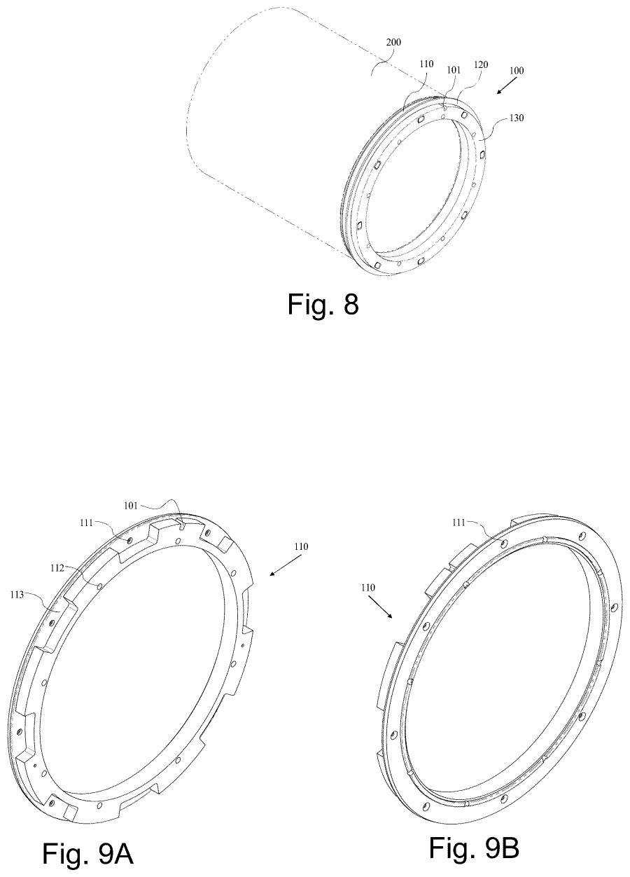

FIG. 8 illustrates a collar 100, according to an embodiment. The collar 100 comprises an inner part 110 configured to be attached to an end of the drum 200, an outer part 130, and a slip part 120 between the inner part 110 and the outer part 130. The inner part 110, the slip part 120 and the outer part 130 are assembled together in succession along an assembly axis. The collar 100 further comprises a groove 101 on an outer perimeter of the collar 100. FIG. 9A illustrates an inner surface of an inner part 110, according to an embodiment. The inner part 110 comprises eight fastening apertures 111 for receiving a pivot for attaching the inner part 110 to an end of the pivot. In other words, the fastening apertures 111 are for securing the pivot and binding parts of the collar, i.e. the inner part, the slip part and the outer part, together. The fastening apertures 111 are arranged at regular intervals at the inner part 110. The inner part 110 further comprises eight attachment apertures 112 for receiving fastening means, such as bolts, for attaching the inner part 110 to an end of the drum. The fastening apertures 112 are arranged at regular intervals at the inner part 110. The inner part 110 further comprises eight mounting recesses 113 for receiving the mounting attachments of the slip part. The mounting recesses 113 are arranged at regular intervals at the inner part 110.

FIG. 9B illustrates an outer surface of an inner part 110, according to an embodiment. The inner part 110 comprises eight fastening apertures 111 for attaching the inner part 110 to an end of the pivot. The fastening apertures 111 are arranged at regular intervals at the inner part 110.

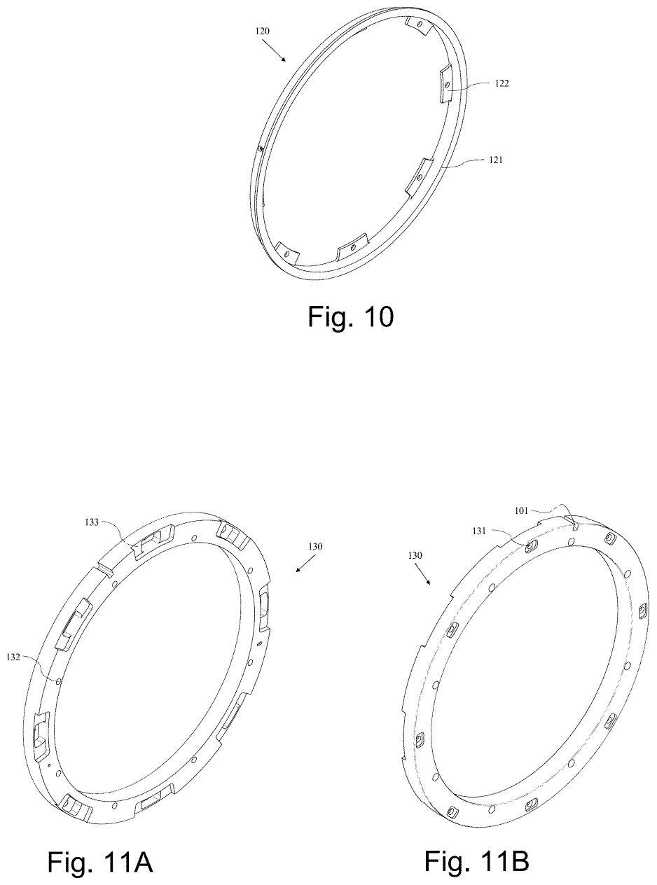

FIG. 10 illustrates a slip part 120, according to an embodiment. The slip part 120 comprises a flange 121 extending perpendicularly to the assembly axis. The slip part 120 further comprises eight mounting attachments 122 protruding towards a centre of the slip part 120 perpendicularly to the assembly axis. The mounting attachments are arranged at regular intervals at the slip part 120.

FIG. 11A illustrates an inner surface of an outer part 130, according to an embodiment. The outer part 130 comprises eight attachment apertures 132 for attaching the collar 100 to the end of the drum. The attachment apertures 132 are arranged at regular intervals at the outer part 110. The outer part 130 further comprises eight mounting recesses 133 for receiving the mounting attachments of the slip part. The mounting recesses 133 form with the mounting recesses 113 of FIG. 9A a sledge where the mounting attachments can translate between the inner part and the outer part along the assembly axis. The mounting recesses 133 are arranged at regular intervals at the outer part 130.

FIG. 11B illustrates an outer surface of an outer part 130, according to an embodiment. An outer surface of the outer part 130 comprises eight pivot recesses 131 for receiving heads of pivots.

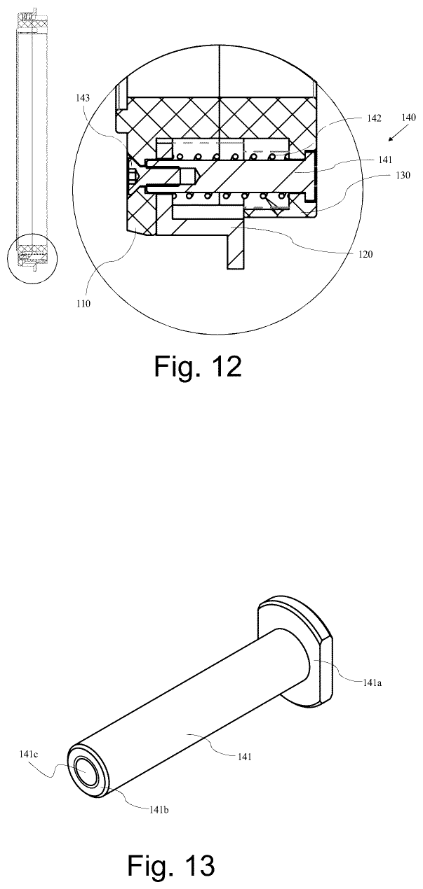

FIG. 12 illustrates a biasing mechanism 140, according to an embodiment. The biasing mechanism 140 comprises a coil spring 142 between a slip part 120 and an outer part 130. A pivot 141 extends through the coil spring 142. A heads of the pivot 141a is arranged inside the outer part 130 so that a surface of the head is substantially at the same level than the outer surface of the outer part 130. An end of the pivot 141b has a recess. A screw 143 extends from an inner part 110 to inside of the recess for attaching the end of the pivot 141b to the inner part 110. A head of the screw 143 is substantially at the same level than the outer surface of the inner part 110.

FIG. 13 illustrates a pivot 141, according to an embodiment. The pivot 141 has a head 141a and an end 141b. The end of the pivot comprises a recess 141c.

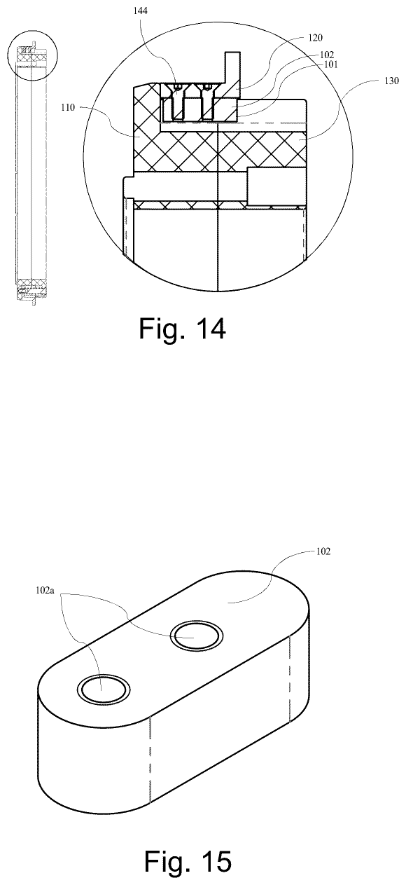

FIG. 14 illustrates a groove 101 on an outer perimeter of the collar 100 and a wedge 102 configured in the groove 101, according to an embodiment. The groove 101 extends from an inner part 110 to an outer part 130. The wedge 102 is attached to a slip part 120 by screws 144.

FIG. 15 illustrates a wedge 102 configured to be placed in the groove, according to an embodiment. The wedge 102 comprises two apertures 102a for receiving screws for attaching the wedge to a slip part.

It is to be understood that the embodiments of the invention disclosed are not limited to the particular structures, process steps, or materials disclosed herein, but are extended to equivalents thereof as would be recognized by those ordinarily skilled in the relevant arts.

It should also be understood that terminology employed herein is used for the purpose of describing particular embodiments only and is not intended to be limiting. suitable manner in one or more embodiments. In the description, numerous specific details are provided, such as examples of lengths, widths, shapes, etc., to provide a thorough understanding of embodiments of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. A sleeve for a drum for use in forming, pressing or moulding a fibrous web, wherein:
the sleeve comprises at least two parts,
each part having a form of an open-ended cylinder with two edges, configured to be arranged concentrically on the drum,
at least one edge of each part has a peripheral locking form, and
wherein adjacent edges of adjacent parts of the at least two parts have corresponding cooperating peripheral locking forms adapted to lock the adjacent parts to each other.

2. The sleeve according to claim 1, wherein parts forming ends of the sleeve have outer edges where a part of points of the outer edges fall on a same plane, which plane is perpendicular to a rotational axis of the sleeve.

3. The sleeve according to claim 1, wherein parts forming ends of the sleeve have outer edges where all points of the outer edges fall on a same plane, which plane is perpendicular to a rotational axis of the sleeve.

4. The sleeve according to claim 2, wherein the sleeve comprises three parts:
a first part having a first outer edge and a second edge with a peripheral locking form,
a second part having a first outer edge and a second edge with a peripheral locking form, and
a third part arranged between the first and the second parts, having peripheral locking forms at both its edges, for locking the parts together.

5. The sleeve according to claim 4, wherein the sleeve comprises several third parts arranged adjacent to one another.

6. The sleeve according to claim 1, wherein the peripheral locking forms are selected from a group consisting of sinusoidal forms, zigzag-forms, and wave forms.

7. The sleeve according to claim 1, wherein one peripheral locking form comprises at least two protrusions and the adjacent peripheral locking form comprises corresponding recesses.

8. The sleeve according to claim 1, wherein one peripheral locking form is a female form and the adjacent peripheral locking form is a corresponding male form.

9. The sleeve according to claim 1, wherein a part of the peripheral locking forms are zigzag-forms.

10. The sleeve according to claim 1, wherein all peripheral locking forms are zigzag-forms.

11. The sleeve according to claim 1, wherein the parts of the sleeve are manufactured by additive manufacturing.

12. The sleeve according to claim 11, wherein the additive manufacturing is stereolithography.

13. The sleeve according to claim 1, wherein the sleeve parts are patterned.

14. The sleeve according to claim 13, wherein a circular locking form is part of the pattern.

15. The sleeve according to claim 1, wherein wall thickness of the sleeve parts is at least 1 mm.

16. A method for securing a sleeve to a drum for use in forming, pressing or moulding a fibrous web, the method comprising:
providing the sleeve according to claim 1;
arranging the at least two parts of the sleeve concentrically on the drum; and
locking the adjacent parts of the sleeve to each other by the corresponding cooperating peripheral locking forms of the adjacent parts.

17. A roll for use in forming, pressing or moulding a fibrous web, comprising:
a drum comprising a backplate,
a sleeve according to claim 1, arranged concentrically on the drum,
a compression collar for compressing the sleeve on the drum between the backplate and the collar, the collar comprising:
an inner part configured to be attached to an end of the drum,
an outer part, and
a slip part between the inner part and the outer part, which slip part is configured to be engaged with the sleeve,
wherein:
the inner part, the slip part and the outer part are assembled together in succession along an assembly axis, and
the slip part is configured to translate between the inner part and the outer part along the assembly axis.
